(19) United States
(12) Patent Application Publication
(10) Pub. No.: US 2016/0357923 A1
(43) Pub. Date: Dec. 8, 2016

(54) DIALYSIS PREDICTIVE MODEL

(71) Applicant: Humana Inc., Louisville, KY (US)

(72) Inventors: Yanting Dong, Lexington, KY (US); Vipin Gopal, Louisville, KY (US)

(21) Appl. No.: 15/057,091

(22) Filed: Feb. 29, 2016

Related U.S. Application Data
(60) Provisional application No. 62/121,792, filed on Feb. 27, 2015.

(51) Int. Cl. G06F 19/00; G06N 7/00

(52) U.S. Cl. CPC G06F 19/345; G06N 7/005

(57) ABSTRACT

The present invention is a method of predicting the likelihood that chronic kidney disease will result in end stage renal disease requiring dialysis. The method uses various indicators comprising information specific to an individual as well as information representing characteristics of a population including demographic information, health care and prescription insurance claims, and involvement in various programs designed to improve the health of a user. The method applies a predictive algorithm to these indicators in order to derive a risk score indicating an individual's risk of dialysis.

### CROSS-REFERENCE TO RELATED APPLICATION

This application claims priority to provisional application No. 62/121,792 filed on Feb. 27, 2015 and is incorporated by reference in its entirety as if fully recited herein.

### TECHNICAL FIELD

Exemplary embodiments of the present invention relate generally to the prediction of chronic kidney disease in a patent population using demographic and clinical condition data predictors as applied to a predictive model.

### BACKGROUND AND SUMMARY OF THE INVENTION

Chronic Kidney disease (CKD) is used to identify conditions that damage a person's kidney in such a manner s to decrease the kidney's ability to filter the waste levels present in the bloodstream. CKD increases a person's risk of developing heart and blood vessel diseases. CKD may develop slowly over time. CKD may be caused by diabetes, high blood pressure and other disorders. According to the National Kidney Foundation®, 26 million American adults have CKD and millions more are at increased risk. It is generally understood that most cases of CKD are caused by diabetes or high blood pressure but these causes still only account for about ⅔ of the CKD cases. The remainder are the result of other disorders, environmental and other factors.

Diagnosing CKD requires medical diagnostic tests. Because the symptoms of CKD develop slowly and aren't necessarily specific to CKD, may people with CKD are not aware that they are suffering from the disease until they are tested. Some people with CKD exhibit no symptoms and aren't aware that they have the disease until tested. Patients who are unaware of their CKD are at greater risk for other health conditions and complications that arise as the result of the failure to treat their undetected CKD. In addition to greater health risks as the result of failure to treat their condition, a worsening of a patient's condition may markedly increase their cost of care, leading to a potentially avoidable need for dialysis treatments that may result from end-stage renal disease (ESRD). Thus, caregivers and insurance providers may have an interest in detecting a patient's CKD condition as early as possible.

In addition to detection, caregivers and insurance providers may have an interest in predicting the likelihood that a patient currently exhibiting CKD symptoms will progress to ESRD and the resultant requirement for dialysis. As with many diseases, the cost to treat a patient's CKD condition may increase significantly as that patient progresses from an early CKD stage to later stages of the disease. This is particularly the case with those exhibiting signs of CKD as the end result may be dialysis, an expensive and uncomfortable treatment. Therefore, a prediction of the likelihood that a segment of population may be at greater risk of suffering a progression of an existing chronic kidney disease condition may be used by caregivers and insurance providers to identify patients with higher levels of risk and proactively initiate monitoring and the provision of appropriate care.

More aggressive testing may help to detect the onset of CKD while increased levels of care to reduce those conditions that could result in CKD may prevent that onset. For persons who already have CKD, increased levels of care may prevent the disease from progressing to more severe stages or at least extend the period of time until disease reaches ESRD. In either case, in addition to helping persons minimize the progression of symptoms, monitoring that results in higher levels of proactive care may have the additional benefit of reducing the cost of providing care or health insurance to such a person.

What is needed is a computerized system and method for identifying segments of a population that are most likely experience a progression in the severity of their CKD resulting in the requirement of dialysis.

Such a system and method may use a severity index to predict the likelihood of disease progression. In embodiments of the invention, input data for use by a predictive model may be collected from a population group. An example of such a group may be persons who are provided coverage by a health insurance provider. In an embodiment of the invention, input data may comprise insurance claims, lab test results, participation in health improvement programs, the output of medical and insurance claim data analysis systems, Medicare data, survey data, population demographics and other population characterizing data. This data may be processed to optimize and transform the various data components into analyzable population data. Predictive models may then be applied to each segment to predict progression risk for population members who are suffering from CKD but not EDRD at the time of analysis. Once such predications have been performed, actions such as testing, treatment, or counseling may be implemented to reduce the predicted occurrences and slow the progression of the disease in those population members which exhibit symptoms.

Further features and advantages of the devices and systems disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a diagram of the various population groups considered by embodiments of the invention when determining a risk for dialysis;

FIG. 2 is a representation of various group members and the occurrences of dialysis among those group members;

FIG. 3 is a chart illustrating data considered by embodiments of the invention when determining the risk dialysis for members;

FIG. 4 is a chart illustrating the predictors considered and their relative includes on the determined risk of dialysis;

FIG. 5 is a chart illustrating the P value of various measures used by a predictive model in an embodiment of the invention; and

FIG. 6 is a chart illustrating the capture rate achieved by a predictive model in an embodiment of the invention.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

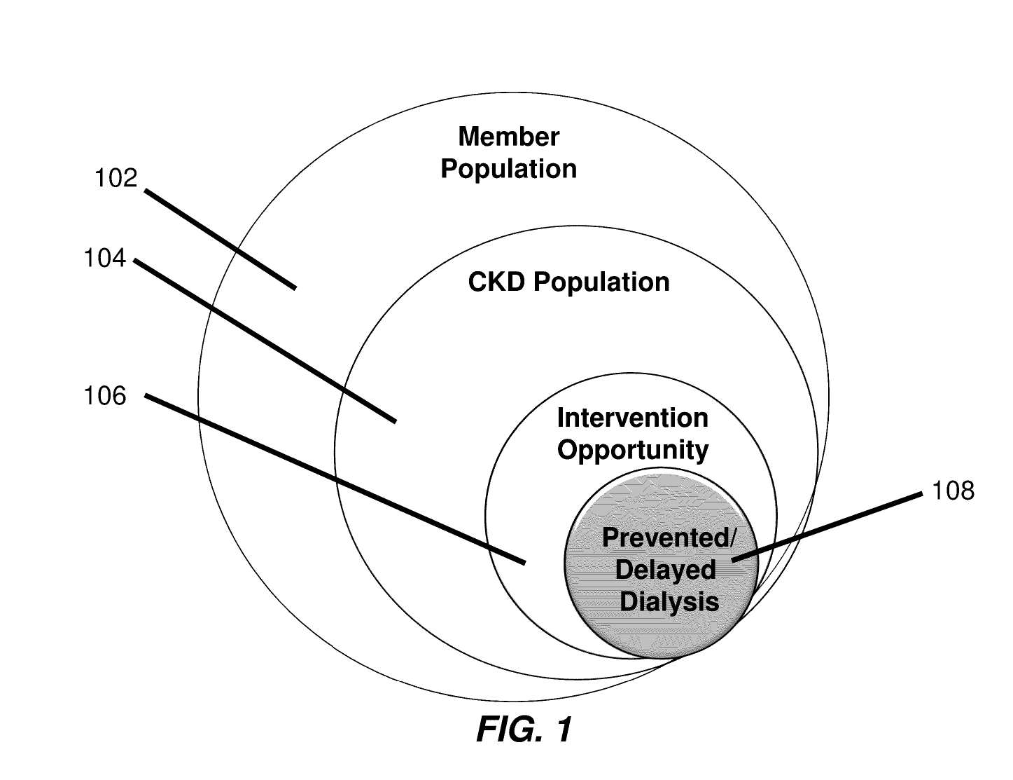

In an example embodiment, a model to predict the likelihood of dialysis is integrated into a software application that may be used by a health insurance provider to predict such a likelihood within a covered patient-member population. As described herein, a model to predict the requirement of dialysis may retrieve and analyze data from a member population for which health insurance is provided by an insurance provider. Referring to FIG. 1, an overall population is indicated at 102. A portion of that population may be experiencing chronic kidney disease (CKD) 104. In embodiments of the invention, this group 104 may be comprised of those members of the overall population which have had an indication of CKD within the last twelve months. Within that population, there may be portion that is likely to require dialysis in the near future 106 and of that portion, there may be a smaller portion which may benefit from treatment in order to delay or prevent the requirement of dialysis 108. Referral as the result of the ability to predict those members of a population which are at greater risk of requiring dialysis may result in the ability to avoid dialysis for a greater period of time than would be the case without such referrals. For example, embodiments of the invention used to predict such members may result a period of time of four months before dialysis is required versus three months when referrals are done without the benefit of a predictive model. In order to identify this smaller population, embodiments of the invention may begin with those members in the group likely to require dialysis 106 and exclude those members that have actually required dialysis within that twelve-month period. The embodiment may also exclude those members who have received kidney transplants or who have been admitted to hospice care. Embodiments of the invention may utilize member health data as well as other member characteristics in order to determine a risk of worsening of CKD that may result in the need for dialysis.

There are many sources of population health data; however, in an embodiment of the invention optimized for use by health insurance providers, one source of such data particularly available to health insurance providers may be claims and health records for the patient-members who form the population. As noted above, an insurance company may have a particular interest in the subject of this invention to assist in the provision of care to individuals who are members of a health plan. In addition to providing improved levels of care to such individuals, early detection and management of the risk of dialysis may reduce the cost of care and thus the cost of health coverage for the member, improving the financial performance of an insurance provider. While the invention should not be interpreted as being limited to health plan members, the term “members” will be used to describe a population for which data is analyzed by embodiments of the invention in order to predict worsening of CKD that may result in dialysis. In other embodiments, those individuals whose medical information and characteristics are being analyzed may also be patients of a care provider and thus may be referred to herein as patients. As noted above, such embodiments may be useful for health plan providers, healthcare providers, and other organizations concerned with the health of population members, and as such, interpretation of this description should not be limited to applications utilized by health plan providers only.

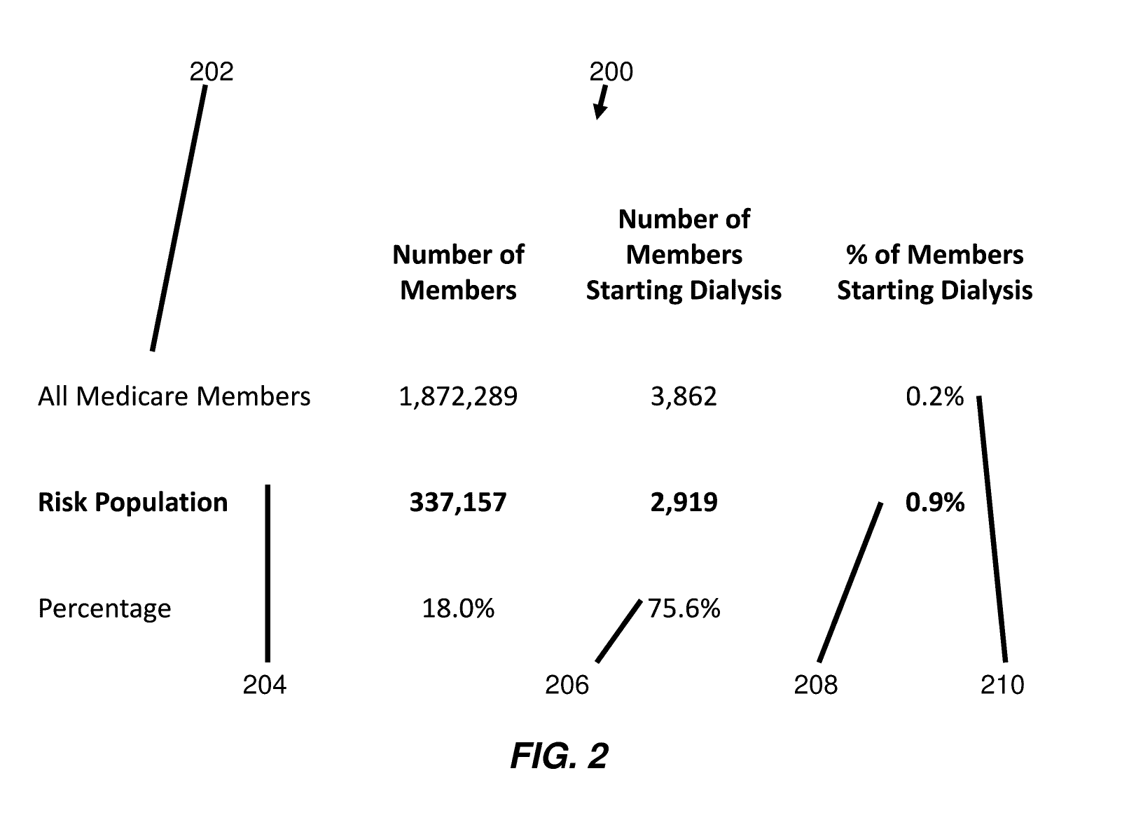

Referring to FIG. 2 which shows another illustration of a larger population 202 and a corresponding number of population members that have been determined to be at risk for dialysis 204. In order to make such a determination, embodiments of the invention may utilize such indicators as chronic kidney disease diagnostic codes promulgated by the U.S. Renal Data System (www.USRDS.org), Optum Nephropathy Diagnosis codes, Chronic Kidney Disease Major Complications and Comorbidity codes (MCC codes) and estimated Glumerular Filtration Rates (eGFR) less than 30 mL/min/1.73 m² (indicative of CKD stages 4 and 5). As is illustrated, when applied to a sample population, such a determination may identify a large percentage of those members who will require dialysis within a period of time 206. As illustrated, the number of members of the risk population 204 who start dialysis is a much larger percentage 208 proportionally that members of the larger group 210.

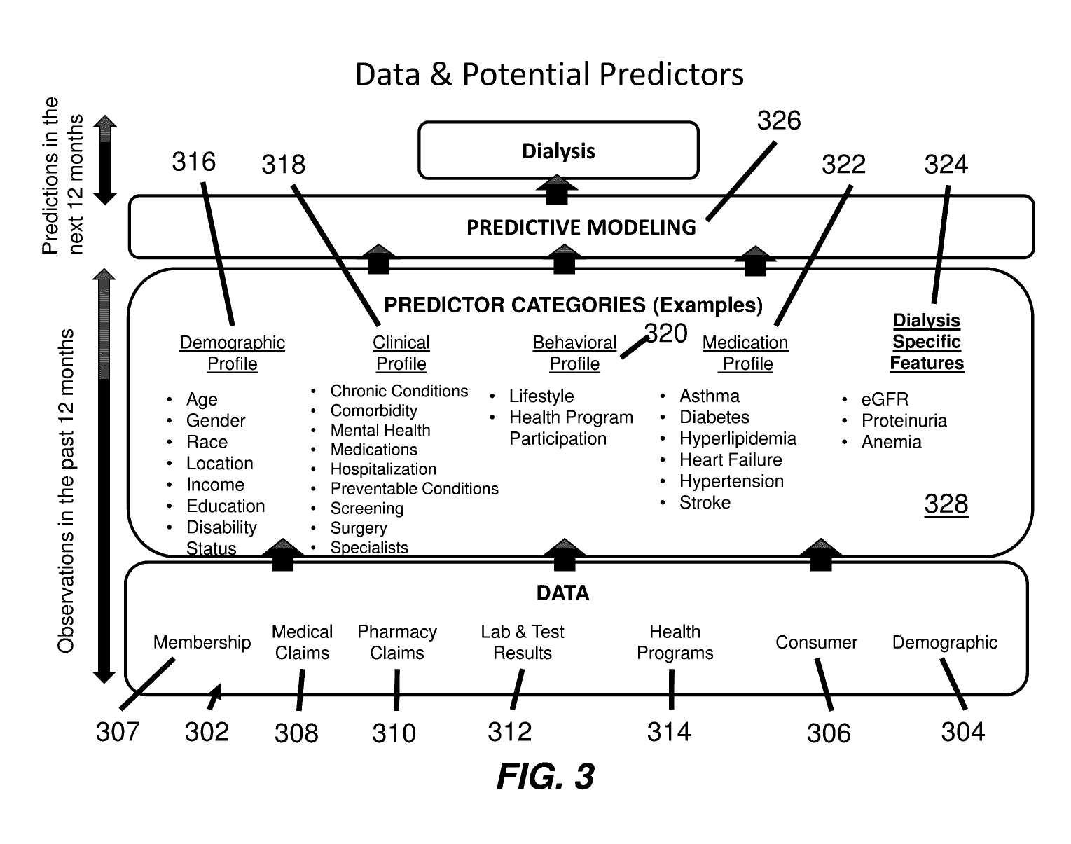

Referring to FIG. 3, input data 302 may be comprised from a plurality of sources. These sources may include both data sources from public repositories demographic 304 and consumer information 306, information derived from health insurance claim data such as general membership information 307 medical claims 308, pharmacy claims 310 and lab and test results 312. Additionally, information regarding member behaviors may be obtained by an insurance provider 314. Examples of such behaviors may be involvement in such activities as weight management and exercise programs. Other sources of data may be derived from member data maintained by health plan providers. Examples of such information may be member health surveys, membership demographics, membership in certain healthcare groups, and participation in various health programs. One example of health surveys which may be used in embodiments of the invention is the Medicare Domain Assessment Tool, in which questions about the patient's health/frailty/mental status are asked. For the membership information, the past coverage of the members may be obtained, which may allow an embodiment of the invention to normalize the past healthcare resources utilizations. A health care provider may provide various disease management programs to help members manage their clinical conditions. The participation of the programs may also provide valuable information about patient's health status and future behavior. Consumer data may provide information about the socio-economic status of a member, such as estimated household income, education, and life-style, which may also play a significant role in predicting the disease progression. Another source of data may be comprised of calculated member data such as health risks alerts generated by a medical analytics system. Input data may also include data from medical records, data from health monitoring devices, social media data, and other sources of data which provide patent behavior or characteristics information.

Because of the diversity of sources from which input data 302 may be comprised, a data feature extraction process may be implemented to identify data variables from the various sources. Extracted data may be optimized through the use of summarization, standardization and filtration processes. The extracted features may describe the patient's demographic profile 316, clinical profile 318, behavior profile 320, medication profile 322 and features that are specific to CKD and the risk of dialysis 324. Example member demographic profile features 316 may include age, gender, race location, income, education, and disability status. Example clinical profiles features 318 may include chronic conditions, comorbidity, mental health conditions, medications, hospitalizations, preventable conditions, screening activities, surgeries, obesity, and specialist interventions. Example behavior profile features 320 may include lifestyle characteristics and behaviors such as smoking, and health program participation. Example medication profile features may include asthma, diabetes, hyperlipidemia, heart failure, hypertension, and stroke. Example features that are specific to CKD and the risk of dialysis may include eGRF rates indication CKD, proteinuria, high levels of uric acid, and anemia. In addition to standardization and filtration, data may be analyzed to detect interactions between the various data sources. An example of such analysis may be processing Medicaid and Medicare record information to identify population risks related to a particular characteristic of a portion of the population. That characteristic may then be used to identify portions of the member data from a health plan provider to optimize the presentation of member data with regard to the identified characteristic.

When data has been processed to extract and transform key data features into standardized data formats, the members identified by the extracted and transformed data may be grouped based on characteristic homogeneity and data availability. Grouping may also be performed based on a variety of hypotheses that are applied to member data. Example hypotheses may include, but are not limited to, relatively short time as members, continuous or existing members, line of business, and other such factors that differentiate members of a population. These examples may be used alone or in combination. Once grouped, the data may have a plurality of models applied to capture the relationship between a member's data characteristics and potential future health conditions for that member 326.

The results of this plurality of models may be subject to various forms of validation testing. Examples of such testing may be the application of models to validate data in order to identify models exhibiting the desired level of performance and then an application of the model to a larger and independent set of test data to verify the results match those of the smaller validation population. This testing may serve to identify the most accurate methods of segmentation and applied models with regard to the predictions derived from their application to sample population data. Once these models are identified, they may be applied to new data in order to perform the prediction and identification desired by the health care or health plan provider which is responsible for the member or patient population.

Models may be applied to the data population. The models may be neural network, logistic regression, decision tree, or similar modeling methods or a combination of several models, i.e. ensemble models. To determine the best models, an embodiment of the invention may apply a plurality of models a sample population segment.

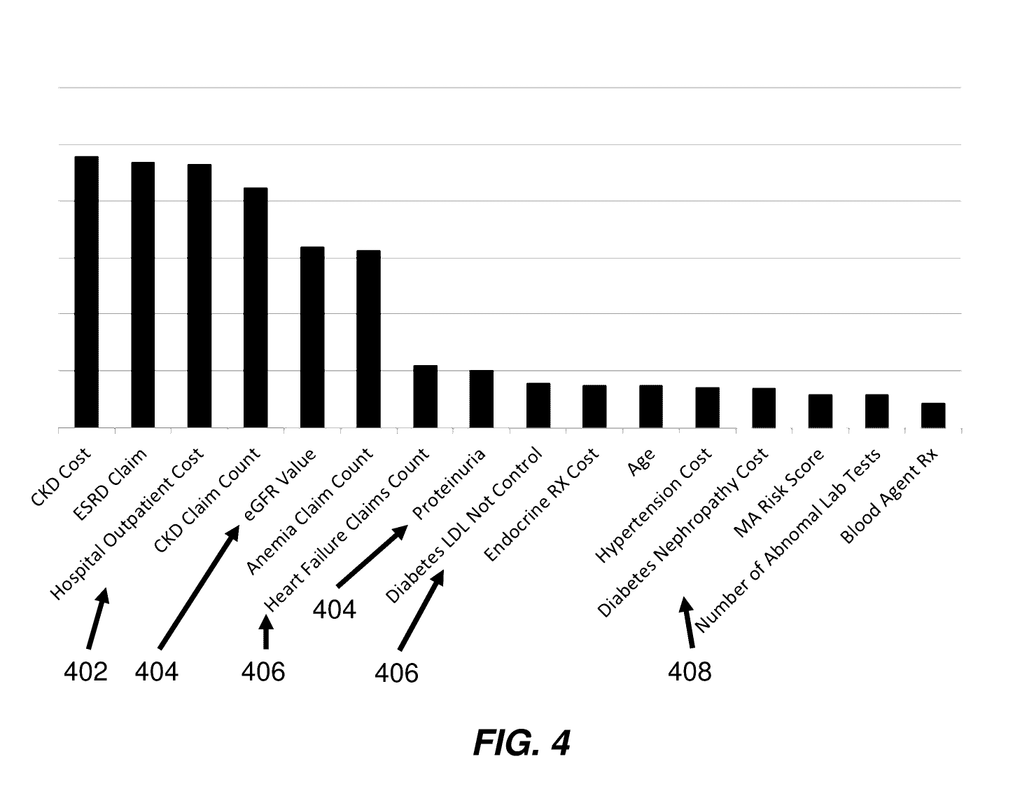

The application of these models may result in the identification of those member characteristics that are more likely to identify members at risk ESRD and thus the requirement for dialysis. As illustrated in FIG. 4, an embodiment of the invention may identify a plurality of predictors most likely to indicate a high risk of dialysis. As illustrated, data related to treatment costs and number of claims 402 may be significant predictors. Other predictors may include test results indicative of CKD 404, and factors related to medical conditions that may aggravate CKD conditions 406. Other predictors 408 may include prescription costs, age, and other cost factors.

Once the best models have been determined for the population segments, an embodiment of the invention may apply those models to segmented population data as illustrated in FIG. 3 at 326. Once these models are applied, a list of members may be produced that is scored according to the risk detected by the plurality of models. The scored member list may be used to initiate phone communications, mailings, or e-mailings to the members or health care providers who provide care to the scored members to help the member or health care provider better manage the identified risk of dialysis. The list may also be used to contact the member for the provision of information to encourage and assist self-management activities by the member. A list of members scored according to dialysis risk may also serve to trigger a proactive visit by a health care provider to a member.

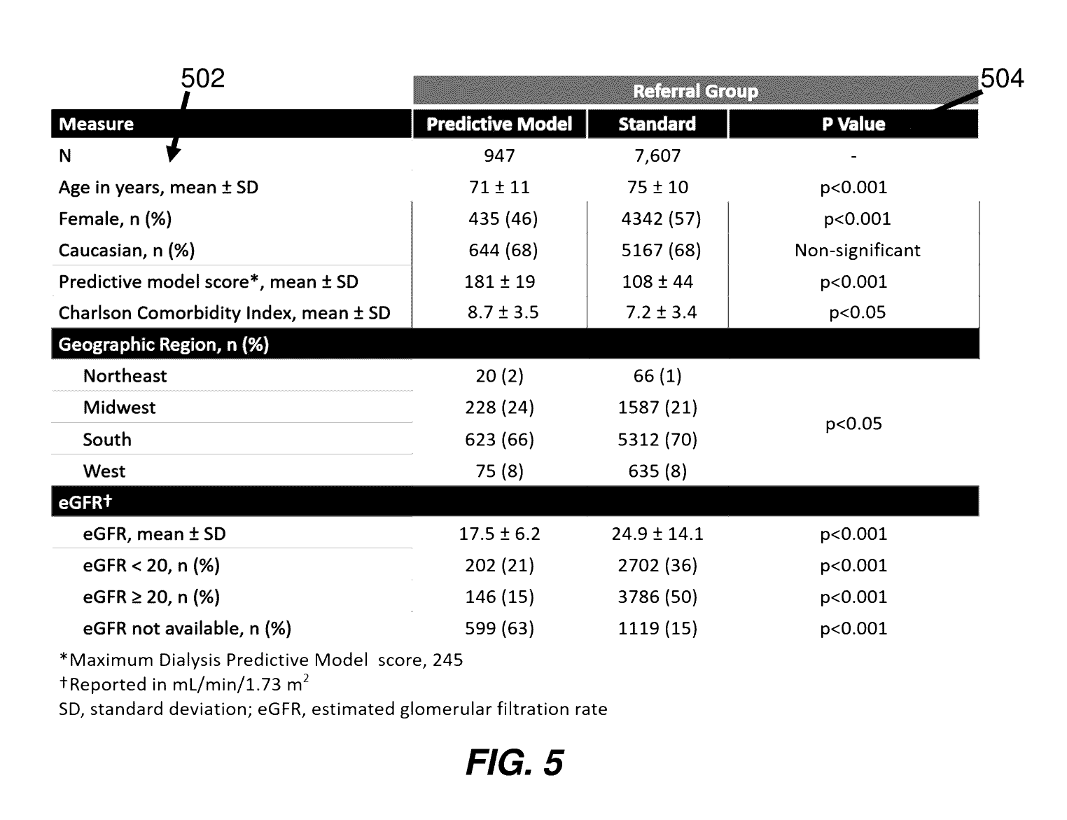

In order to test the effectiveness of the model or models applied to input data, the output of the predictive model may be applied to member data. In an example embodiment of such testing, member characteristics may be compared to claims data obtained from those members of a health insurance provider to which the predictive model was applied. As illustrated in FIG. 5, various member characteristics identified as predictor categories 502 (see FIG. 3 at 328), may be analyzed to determine their P value as illustrated at 504. Such member data may be randomly selected or may comprise a preselected portion of claims data for a predetermined time period.

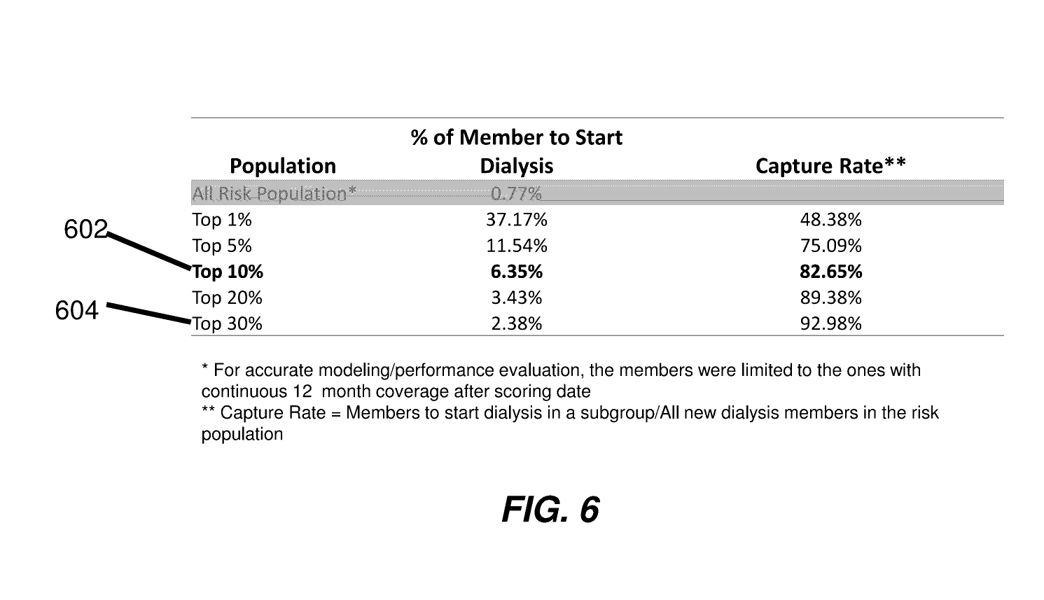

As is shown in FIG. 6, the incidence of the dialysis in a test population using an embodiment of the predictive model increases according the percentage of population sorted according to predicted risk level. Thus, one ordinarily skilled in the art will appreciate that the risk prediction model applied to the analyzed member data is significantly more likely to predict the occurrence of dialysis in the analyzed population than random selection. As illustrated 602, in an embodiment of the predictive model, a capture rate (representing the percentage of members in and predicted risk score range who start dialysis divided versus the entire at risk population 204 requiring dialysis) is over 82% for the highest 10% of risk scores. The top 20% of those members ranked according the predictive model yielded approximately 89%, and so-on as the percentage of ranked members is increased. On ordinarily skilled in the art will understand that using such a model, a user could identify a portion of the higher risk scores for intervention and be assured of contacting a large percentage of those population members that are likely to require dialysis. For example, as illustrated at 604, contacting the top 30 percent of members according to predicted risk score would likely result in a capture rate of nearly 93 percent of those members who will require dialysis.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A method for predicting the onset of end stage renal disease in a population suffering from chronic kidney disease comprising the steps of:
receiving health related patient data from a plurality of sources;
performing an extraction process upon the received data to extract features that describe at least one member of the population;
processing the extracted data; and
applying a predictive model to the data that identify the relationships between characteristics of the data and the transition from chronic kidney disease to end stage renal disease for at least one member to generate a risk score for that member.

2. The method of claim 1, wherein the step of processing the extracted data is performed using a summarization process, a standardization process, and a filtration process.

3. The method of claim 1, wherein the predictive model applied is selected from a list comprising a neural network, logistic regression, or a decision tree.

4. The method of claim 1, wherein the extracted features to which the predictive model is applied is selected by verifying the features using holdout data to determine the selection of features which result in a model with the greatest accuracy.

5. The method of claim 1, wherein the received data comprises at least one of: membership data, participation in programs to improve the health of a participant, data representing demographics of the group of individuals, data comprising medical lab test results for the group of individuals, insurance claims by members of the group of individuals for medical care, insurance claims by members of the group for pharmacy services, and consumer data regarding the members.

6. The method of claim 1, wherein the extracted features comprise at least one of: a member's demographic profile, a member's clinical profile, a member's behavior profile, a member's medication profile, and a member's dialysis specific features.

7. The method of claim 1, wherein the predictive model is applied in response to a user input selection.

8. A method for determining the most accurate model for predicting the likelihood that a patient with chronic kidney disease will require dialysis comprising the steps of:
receiving historical health related data from a plurality of sources;
performing an extraction process upon the received data to extract features that describe at least one patient;
processing the extracted data;
applying a plurality of models to the processed data which identify relationships between characteristics of the data and progression of chronic kidney disease to the requirement of dialysis in the described patient(s);
comparing the relationships identified by the plurality of models to data representing actual patient outcomes; and
selecting one of the plurality of the applied models with the relationship that most accurately reflects the actual patient outcome.

9. The method of claim 8, wherein the step of processing the extracted data is performed using a summarization process, a standardization process, and a filtration process.

10. The method of claim 8, wherein application of the model produces a list of patients arranged progressively from a low risk to a high risk of progressing from chronic kidney disease to the requirement of dialysis.

11. The method of claim 8, wherein the plurality of models applied comprise at least one of a neural network model, a logistic regression model, or a decision tree model.

12. The method of claim 8, wherein the model applied is selected by verifying each of the plurality of models using holdout data to determine the accuracy of each model and the model with the greatest accuracy is selected.

13. The method of claim 8, wherein the received data comprises at least one of: health surveys received from a group of individuals, data representing demographics of the group of individuals, data comprising summarized medical lab test results for the group of individuals, insurance claims by members of the group of individuals for medical care, insurance claims by members of the group for pharmacy services, and consumer data regarding the members.

14. The method of claim 8, wherein the extracted features comprise at least one of: a patient's demographic profile, a patient's clinical profile, a patient's behavior profile, a patient's medication profile, and a member's dialysis specific features.

15. A method for predicting the onset of end stage renal disease in a population suffering from chronic kidney disease comprising the steps of:
receiving health related patient data from a plurality of sources;
performing an extraction process upon the received data to extract features that describe at least one member of the population;
processing the extracted data;
determining the most accurate model for predicting the likelihood that a patient with chronic kidney disease will require dialysis be performing the substeps of:
receiving historical health related data from a plurality of sources;
performing an extraction process upon the received historical data to extract features that describe at least one patient;
processing the extracted data;
applying a plurality of models to the processed extracted data which identify relationships between characteristics of the data and progression of chronic kidney disease to the requirement of dialysis in the described patient(s);
comparing the relationships identified by the plurality of models to data representing actual patient outcomes from the historical data; and
selecting one of the plurality of the applied models with the relationship that most accurately reflects the actual patient outcome; and
applying the selected predictive model to the data that identifies the relationships between characteristics of the data and the transition from chronic kidney disease to end stage renal disease for at least one member to generate a risk score for that member.

16. The method of claim 15, wherein the step of processing the extracted data is performed using a summarization process, a standardization process, and a filtration process.

17. The method of claim 15, wherein the predictive model applied is selected from a list comprising a neural network, logistic regression, or a decision tree.

18. The method of claim 15, wherein the extracted features to which the predictive model is applied is selected by verifying the features using holdout data to determine the selection of features which result in a model with the greatest accuracy.

19. The method of claim 15, wherein the received data comprises at least one of: membership data, participation in programs to improve the health of a participant, data representing demographics of the group of individuals, data comprising medical lab test results for the group of individuals, insurance claims by members of the group of individuals for medical care, insurance claims by members of the group for pharmacy services, and consumer data regarding the members.

20. The method of claim 15, wherein the extracted features comprise at least one of:
a member's demographic profile, a member's clinical profile, a member's behavior profile, a member's medication profile, and a member's dialysis specific features.
